(19) United States
(12) Patent Application Publication
(10) Pub. No.: US 2005/0234610 A1
(43) Pub. Date: Oct. 20, 2005

(54) Automotive movable body, movable body control method and computer program

(75) Inventors: Akio Shimizu, Osaka (JP); Tomoyoshi Tokumaru, Osaka (JP); Tatsuya Hirose, Osaka (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/100,426

(22) Filed: Apr. 7, 2005

(30) Foreign Application Priority Data
Apr. 20, 2004 (JP) 2004-124788

(51) Int. Cl. G05D 1/00

(52) U.S. Cl. 701/23; 701/26

(57) ABSTRACT

Provided are: an automotive movable body capable of moving to an entire area surrounded by a wall excluding an area where an obstacle exists no matter what shape an obstacle existing within the area has; a movable body control method; and a recording medium storing a computer program. An automotive movable body for which moving algorithm is specified moves toward an object detected at the time of start of moving and judges whether the distance to the object is shorter than a predetermined value or not. When it is judged that the distance is shorter than a predetermined value, the body moves a first distance along the object, then moves a second distance in a direction intersecting the segment connecting the position before moving with the position after moving, and then moves toward the position where moving of the second distance is started after turning around at approximately 180°.

### CROSS-REFERENCE TO RELATED APPLICATIONS

This Nonprovisional application claims priority under 35 U.S.C. §119(a) on Patent Application No. 2004-124788 filed in Japan on Apr. 20, 2004, the entire contents of which are hereby incorporated by reference.

### BACKGROUND OF THE INVENTION

The present invention relates to: an automotive movable body, such as an automotive vacuum cleaner or an automotive lawn mower, capable of moving within an area surrounded by a boundary such as a wall; a movable body control method; and computer program.

With rapid advancement of robot control technology in recent years, some automotive movable bodies which can be utilized at home, such as an automotive vacuum cleaner and an automotive lawn mower, are being introduced into the market. Such an automotive movable body comprises a sensor for detecting a wall standing around, an obstacle existing within the area in which the body may move or the like, so that a predetermined operation can be performed smoothly without the need for observation and help from the user by controlling the moving direction according to a wall, an obstacle or the like when the sensor detects the wall, the obstacle or the like.

For example, an automotive vacuum cleaner disclosed in Japanese Patent Application Laid-Open No. H7-319542 moves to the nearest wall from a state where it is located, moves a predetermined distance along the wall and then moves to another wall which exists in the opposite position. The cleaner moves a predetermined distance along the wall and then moves to the wall (former wall) which exists in the opposite position. The cleaner can move in a zigzag in a room and clean the entire area by repeatedly performing such a process.

Moreover, an automotive vacuum cleaner disclosed in Japanese Patent Application Laid-Open No. H9-179625 moves to the nearest wall from a state where it is located in an oblique direction with respect to the wall, and when it comes into contact with or close to the wall, moves to another wall which exists in the opposite position in the normal direction of the wall which the cleaner has come into contact with or close to. When it comes into contact with or close to the wall, the cleaner moves toward the wall which exists in the opposite position in the normal direction of the wall which the cleaner has come into contact with or close to. The cleaner can move in a zigzag in a room and clean the entire area by repeatedly performing such a process.

However, the automotive vacuum cleaner disclosed in Japanese Patent Application Laid-Open No. H7-319542 has a problem that it can move only in one side area of an obstacle and cannot move to the other side area when an obstacle exists between the opposing walls, or it cannot get out of a dead end only by the zigzag moving control and cannot clean the entire area when a dead end is formed due to the shape of the wall.

Moreover, the automotive vacuum cleaner disclosed in Japanese Patent Application Laid-Open No. H9-179625 has a problem that, when a substantially cylindrical obstacle exists between the opposing walls when a substantially cylindrical obstacle exists between the opposing walls, the cleaner moves away from the obstacle in the normal direction of a substantially cylindrical obstacle which the cleaner has come into contact with or close to and then moves again to the obstacle in a direction having a predetermined angle with respect to the normal direction of the obstacle, that is, the cleaner makes revolution movement while going radially away from the substantially cylindrical obstacle and back to the obstacle. Thus, once the cleaner detects the existence of the substantially cylindrical obstacle, the cleaner cannot go away from the obstacle and cannot clean the entire area.

Furthermore, though the position of the movable body can be specified with high accuracy using an expensive position specifying device, such as the GPS, such a device is very expensive and is impractical from the cost-effect standpoint when the device is used for a movable body to be used in a small area, in particular, a garden, a room or the like at home.

### BRIEF SUMMARY OF THE INVENTION

The present invention has been made with the aim of solving the above problems, and it is an object thereof to provide: an automotive movable body capable of moving to an entire area surrounded bay a wall excluding an area where an obstacle exists no matter what shape the obstacle existing within the area has; a movable body control method; and a computer program.

Another object of the present invention is to provide: an automotive movable body capable of moving along the entire length of a surrounding wall no matter what shape the wall has; a movable body control method; and computer program.

An automotive movable body according to the present invention aiming at attaining the above objects is an automotive movable body comprising: a driven wheel; an actuator for driving the driven wheel; a sensor for detecting an object which exists in the vicinity; a control unit for controlling an operation of the driven wheel according to a detection result of the sensor; and a moved distance calculating unit for calculating a moved distance from a moving starting position, characterized in that the control unit comprises: first driving signal outputting means for outputting to the actuator a driving signal capable of causing the body to move along an object; first judging means for judging whether the distance calculated by the moved distance calculating unit is up to a first distance or not; second driving signal outputting means for outputting to the actuator a driving signal capable of causing the body to move in a direction which intersects with a segment connecting a position before moving with a position after moving, when the first judging means judges that the distance is up to the first distance; second judging means for judging whether the distance calculated by the moved distance calculating unit is up to a second distance or not; and third driving signal outputting means for outputting to the actuator a driving signal capable of causing the body to turn around at approximately 180°, when the second judging means judges that the distance is up to the second distance or when the sensor detects an object.

With the present invention, after the body moves a predetermined distance along a wall, after the body moves a predetermined distance different from said distance in a direction substantially perpendicular to a segment connecting a position before moving with a position after moving, or when the sensor detects an object in the course of moving a predetermined distance, the body turns around at approximately 180° and moves toward a moving starting position in a direction, for example, substantially perpendicular to the segment connecting a position before moving with a position after moving. In this manner, since the body can surely go back to a position where moving away from a wall is started no matter what shape the wall has, the body can move along the substantially entire inner surface of the wall and can move to the entire area excluding an area where an obstacle exists no matter what shape the obstacle existing within the area surrounded by the wall has.

Moreover, an automotive movable body according to the present invention is characterized by comprising: fourth driving signal outputting means for outputting to the actuator a driving signal capable of causing the body to move toward an object detected by the sensor after moving is started; distance calculating means for calculating a distance to a detected object, when the sensor detects the object; and third judging means for judging whether the distance calculated by the distance calculating means is shorter than a predetermined value or not.

With the present invention, the body first moves to a wall detected by the sensor, and when it is judged that the distance to the wall is shorter than a predetermined value (including a case where the body comes into contact with the wall), the body moves a predetermined distance along the wall. In this manner, since the body can move to a reachable position along the inner surface of the wall no matter what shape the wall has, the body can move to the entire area surrounded by the wall excluding an area where an obstacle exist no matter what shape the obstacle existing within the area has.

Moreover, an automotive movable body according to the present invention comprises: a driven wheel; an actuator for driving the driven wheel; a sensor for detecting an object which exists in the vicinity; a control unit for controlling an operation of the driven wheel according to detection result of the sensor; and a moved distance calculating unit for calculating a moved distance from a moving starting position, the control unit comprising a processor capable of performing the following operations of outputting to the actuator a driving signal capable of causing the body to move along an object; judging whether the distance calculated by the moved distance calculating unit is up to a first distance or not; outputting to the actuator a driving signal capable of causing the body to move in a direction which intersects with a segment connecting a position before moving with a position after moving, when it is judged that the distance is up to the first distance; judging whether the distance calculated by the moved distance calculating unit is up to a second distance or not; and outputting to the actuator a driving signal capable of causing the body to turn around at approximately 180°, when it is judged that the distance is up to the second distance or when the sensor detects an object.

With the present invention, after the body moves a predetermined distance along a wall, after the body moves a predetermined distance different from said distance in a direction substantially perpendicular to a segment connecting a position before moving with a position after moving, or when the sensor detects an object in the course of moving a predetermined distance, the body turns around at approximately 180° and moves toward a moving starting position in a direction, for example, substantially perpendicular to the segment connecting a position before moving with a position after moving. In this manner, since the body can surely go back to a position where moving away from a wall is started no matter what shape the wall has, the body can move along the substantially entire length of the inner surface of the wall and can move to the entire area surrounded by the wall excluding an area where an obstacle exists no matter what shape the obstacle existing within the area has.

Moreover, in an automotive movable body according to the present invention, the processor is further capable of performing the following operations of outputting to the actuator a driving signal capable of causing the body to move toward an object detected by the sensor after moving is started; calculating a distance to a detected object, when the sensor detects the object; and judging whether the calculated distance is shorter than a predetermined value or not.

With the present invention, the body first moves toward a wall detected by the sensor, and when it is judged that the distance to the wall is shorter than a predetermined value (including a case where the body comes into contact with the wall), the body moves a predetermined distance along the wall. In this manner, since the body can move to a reachable position along the inner surface of the wall no matter what shape the wall has, the body can move to the entire area surrounded by the wall excluding an area where an obstacle exists no matter what shape the obstacle existing within the area has.

Moreover, an automotive movable body according to the present invention comprises a plurality of sensors, wherein the processor is further capable of performing the following operations of calculating a moving direction with respect to an object on the basis of detection results of the plurality of sensors, when it is judged that the distance to the detected object is longer than a predetermined value; judging whether the calculated moving direction differs from a normal direction of a surface of the object detected on the basis of detection results of the plurality of sensors or not; and correcting a driving signal to be sent to the actuator according to a difference between the calculated moving direction and the normal direction of the surface of the detected object, when it is judged that the calculated moving direction differs from the normal direction of the surface of the detected object.

With the present invention, the moving direction toward a wall is obtained on the basis of a difference between distances to the wall detected by a plurality of sensors, such as sensors provided on the right and left, and when the obtained moving direction differs from a direction substantially perpendicular to the wall surface, the moving direction is corrected according to an angle of difference. In this manner, even when it is difficult to move straight toward the wall detected first by a sensor due to the state of the floor surface, such as floor surface roughness, the body can move toward the wall while correcting the moving direction according to detection result of the plurality of sensors, so that the movable body can move while judging the position of the movable body accurately without using position measuring means which is expensive and of high precision.

Moreover, an automotive movable body according to the present invention comprises a plurality of sensors, wherein the processor is further capable of performing the following operations of calculating a moving direction with respect to an object on the basis of detection results of the plurality of sensors, when it is judged that the distance to the detected object is shorter than a predetermined value; and storing the calculated moving direction, wherein the processor outputs to the actuator a driving signal having a corrected turning around direction according to the stored moving direction.

With the present invention, the moving direction at the time of being up to a wall is obtained on the basis of a difference between distances to the wall detected by a plurality of sensors, such as sensors provided on the right and left, and when the obtained moving direction differs from a direction substantially perpendicular to the wall, the moving direction for going back toward the wall next is corrected according to an angle of difference. In this manner, even when it is difficult to move straight toward the wall after going away from the wall and turning around due to the state of the floor surface, such as floor surface roughness, the body can move toward the wall after correcting the moving direction according to detection results of the plurality of sensors after going away from the wall next and turning around, so that the body can move after correcting the moving direction of the movable body toward the wall according to the floor surface without using position measuring means which is expensive and of high precision.

Moreover, an automotive movable body according to the present invention comprises a plurality of sensors, wherein the processor is further capable of performing the following operations of: calculating a moving direction with respect to an object on the basis of detection results of the plurality of sensors, when it is judged that the distance to the detected object is longer than a predetermined value; judging whether the calculated moving direction differs from a moving direction specified by the sent driving signal or not; and correcting a driving signal to be sent to the actuator according to a difference between two moving directions, when it is judged that two moving directions differ from each other.

With the present invention, the moving direction toward a wall is obtained on the basis of a difference between distances to the wall detected by a plurality of sensors, such as sensors provided on the right and left, and when the obtained moving direction differs from a moving direction away from the wall before turning around, the moving direction is corrected according to an angle of difference. In this manner, even when it is difficult to move straight to the wall due to the state of the floor surface, such as floor surface roughness, after going away from the wall and turning around, the body can go back to a position where moving away from the wall is started while correcting the moving direction with high accuracy according to detection results of the plurality of sensors, so that the body can move while judging the position of the movable body accurately without using position measuring means which is expensive and of high precision.

Moreover, in an automotive movable body according to the present invention, the processor is further capable of performing the following operations of calculating a moved distance before turning around covered before a driving signal capable of causing turning around at approximately 180° is sent to the actuator; calculating a moved distance after turning around; judging whether the moved distance after turning around is shorter than the moved distance before turning around or not, when the sensor detects existence of an object; and outputting to the actuator a driving signal capable of avoiding the detected object, when it is judged that the moved distance after turning around is shorter than the moved distance before turning around.

With the present invention, when the sensor detects an object in the course of moving toward a surrounding wall after turning around at approximately 180°, whether the object is an obstacle or a wall is judged on the basis of whether the distance to the object is shorter than a predetermined distance or not, and when the distance to the object is shorter than a predetermined distance, it is judged that the object is an obstacle and the body moves so as to avoid the obstacle by, for example, moving round to the right or left. In this manner, the body can go back to a position where moving away from the wall is started even when an obstacle exists in the course of going back to the wall and can move along the substantially entire length of the inner surface of the wall, so that the body can move to the entire area excluding an area where the obstacle exists.

Next, a movable body control method according to the present invention aiming at attaining the above objects is a movable body control method, which comprises: a driven wheel; an actuator for driving the driven wheel; a sensor for detecting an object which exists in the vicinity; and a moved distance calculating unit for calculating a moved distance from a moving starting position, for controlling an operation of the driven wheel according to a detection result of the sensor, characterized by comprising: a first driving signal outputting step of outputting to the actuator a driving signal capable of causing the body to move along an object; a first judging step of judging whether the distance calculated by the moved distance calculating unit is up to a first distance or not; a second driving signal outputting step of outputting to the actuator a driving signal capable of causing the body to move in a direction which intersects with a segment connecting a position before moving with a position after moving, when it is judged in the first judging step that the distance is up to the first distance; a second judging step of judging whether the distance calculated by the moved distance calculating unit is up to a second distance or not; and a third driving signal outputting step of outputting to the actuator a driving signal capable of causing the body to turn around at approximately 180°, when it is judged in the second judging step that the distance is up to the second distance or when the sensor detects an object.

With the present invention, after the body moves a predetermined distance along a wall, after the body moves a predetermined distance different from said distance in a direction substantially perpendicular to a segment connecting a position before moving with a position after moving, or when the sensor detects an object in the course of moving a predetermined distance, the body turns around at approximately 180° and moves toward a moving starting position in a direction, for example, substantially perpendicular to the segment connecting a position before moving with a position after moving. In this manner, since the body can surely go back to a position where moving away from a wall is started no matter what shape the wall has, the body can move along the substantially entire inner surface of the wall and can move to the entire area surrounded by the wall excluding an area where an obstacle exists no matter what shape the obstacle existing within the area has.

Next, computer program according to the present invention aiming at attaining the above objects is a computer program executable by a computer, which comprises: a driven wheel; an actuator for driving the driven wheel; a sensor for detecting an object which exists in the vicinity; and a moved distance calculating unit for calculating a moved distance from a moving starting position, for controlling an operation of the driven wheel according to a detection results of the sensor, characterized by comprising: a first driving signal outputting step of outputting to the actuator a driving signal capable of causing the body to move along an object; a first judging step of judging whether the distance calculated by the moved distance calculating unit is up to a first distance or not; a second driving signal outputting step of outputting to the actuator a driving signal capable of causing the body to move in a direction which intersects with a segment connecting a position before moving with a position after moving, when it is judged in the first judging step that the distance is up to the first distance; a second judging step of judging whether the distance calculated by the moved distance calculating unit is up to a second distance or not; and a third driving signal outputting step of outputting to the actuator a driving signal capable of causing the body to turn around at approximately 180°, when it is judged in the second judging step that the distance is up to the second distance or when the sensor detects an object.

With the present invention, after the body moves a predetermined distance along a wall, after the body moves a predetermined distance different from said distance in a direction substantially perpendicular to a segment connecting a position before moving with a position after moving, or when the sensor detects an object in the course of moving a predetermined distance, the body turns around at approximately 180° and moves toward a moving starting position in a direction, for example, substantially perpendicular to the segment connecting a position before moving with a position after moving. In this manner, since the body can surely go back to a position where moving away from a wall is started no matter what shape the wall has, the body can move along the substantially entire inner surface of the wall and can move to the entire area surrounded by the wall excluding an area where an obstacle exists no matter what shape the obstacle existing within the area has.

With the present invention, since the body can move along the substantially entire inner surface of the wall no matter what shape the wall has, the body can move to the entire area surrounded by the wall excluding an area where an obstacle exists no matter what shape the obstacle existing within the area has.

Moreover, with the present invention, since the body can move to a reachable position along the inner surface of the wall no matter what shape the wall has, the body can move to the entire area surrounded by the wall excluding an area where an obstacle exist no matter what shape the obstacle existing within the area has.

Moreover, with the present invention, even when it is difficult to moving straight toward the wall detected first by a sensor due to the state of the floor surface, such as floor surface roughness, the body can move toward the wall while correcting the moving direction according to detection results of the plurality of sensors, so that the movable body can move while judging the position of the movable body accurately without using position measuring means which is expensive and of high precision.

Moreover, with the present invention, even when it is difficult to move straight toward the wall after going away from the wall and turning around due to the state of the floor surface, such as floor surface roughness, the body can move toward the wall after correcting the moving direction according to detection results of the plurality of sensors after going away from the wall next and turning around, so that the body can move after correcting the moving direction of the movable body toward the wall according to the floor surface without using position measuring means which is expensive and of high precision.

Moreover, with the present invention, even when it is difficult to move straight toward the wall due to the state of the floor surface, such as floor surface roughness, after going away from the wall and turning around, the body can move toward the wall while correcting the moving direction according to detection results of the plurality of sensors, so that the movable body can move while judging the position of the movable body accurately without using position measuring means which is expensive and of high precision.

Moreover, with the present invention, the body can go back to a position where moving away from the wall is started even when an obstacle exists in the course of going back to the wall and can move along the substantially entire inner surface of the wall, so that the body can move to the entire area excluding an area where the obstacle exists.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing an example of the schematic structure of an automotive movable body according to Embodiment 1 of the present invention;

FIG. 2 is a block diagram showing the structure of a control unit;

FIG. 3 is a flow chart showing the operational control procedure of the control unit of the automotive movable body according to Embodiment 1 of the present invention;

FIGS. 4A and 4B are flow charts showing the operational control procedure of the control unit of the automotive movable body according to Embodiment 1 of the present invention;

FIG. 5 is an explanatory view showing a method for calculating a direction in which the body is to move to go away from a wall;

FIG. 6 is an explanatory view showing a method for calculating a direction in which the body is to move to go away from a wall;

FIG. 7 is a view showing a moving path of the automotive movable body which is located at a moving starting position P;

FIG. 8 is a flow chart showing the operational control procedure of a control unit of an automotive movable body according to Embodiment 2 of the present invention;

FIG. 9 is a flow chart showing the operational control procedure of the control unit of the automotive movable body according to Embodiment 2 of the present invention;

FIG. 10 is a flow chart showing the operational control procedure of a control unit of an automotive movable body according to Embodiment 3 of the present invention;

FIGS. 11A and 11B are flow charts showing the operational control procedure of the control unit of the automotive movable body according to Embodiment 3 of the present invention; and

FIGS. 12A and 12B are flow charts showing the operational control procedure of a control unit of an automotive movable body according to Embodiment 4 of the present invention.

### DETAILED DESCRIPTION OF THE INVENTION

As described above, the automotive vacuum cleaner disclosed in Japanese Patent Application Laid-Open No. H7-319542 has a problem that, when an obstacle exists between opposing surfaces of a wall, the cleaner can move only in one side area of the obstacle and cannot move to the other side area, or when a dead end is formed due to the shape of the wall, the cleaner cannot get out of a dead end only by the zigzag moving control and cannot clean the entire area.

Moreover, the automotive vacuum cleaner disclosed in Japanese Patent Application Laid-Open No. H9-179625 has a problem that, when a substantially cylindrical obstacle exists between opposing surfaces of a wall, the cleaner moves away from an obstacle in the normal direction of a substantially cylindrical obstacle which the cleaner has come into contact with or close to and then moves again toward the obstacle in a direction having a predetermined angle with respect to the normal direction of the obstacle, that is, the cleaner makes revolution movement while going radially away from the substantially cylindrical obstacle and back to the obstacle. Thus, once the cleaner detects the existence of the substantially cylindrical obstacle, the cleaner cannot go away from the obstacle and cannot clean the entire area.

Furthermore, though the position of the movable body can be specified with high accuracy using an expensive position specifying device, such as the GPS, such a device is very expensive and is impractical from the cost-effect standpoint when the device is used for a movable body to be used in a small area, in particular, a garden, a room or the like at home.

The present invention has been made with the aim of solving the above problems, and it is an object thereof to provide: an automotive movable body capable of moving to the entire area surrounded bay a wall excluding an area where an obstacle exists no matter what shape the obstacle existing within the area has; a movable body control method; and computer program.

Another object of the present invention is to provide: an automotive movable body capable of moving along the entire length of a surrounding wall no matter what shape the wall has; a movable body control method; and computer program.

The following description will explain the present invention with reference to the drawings illustrating some embodiments thereof.

### Embodiment 1

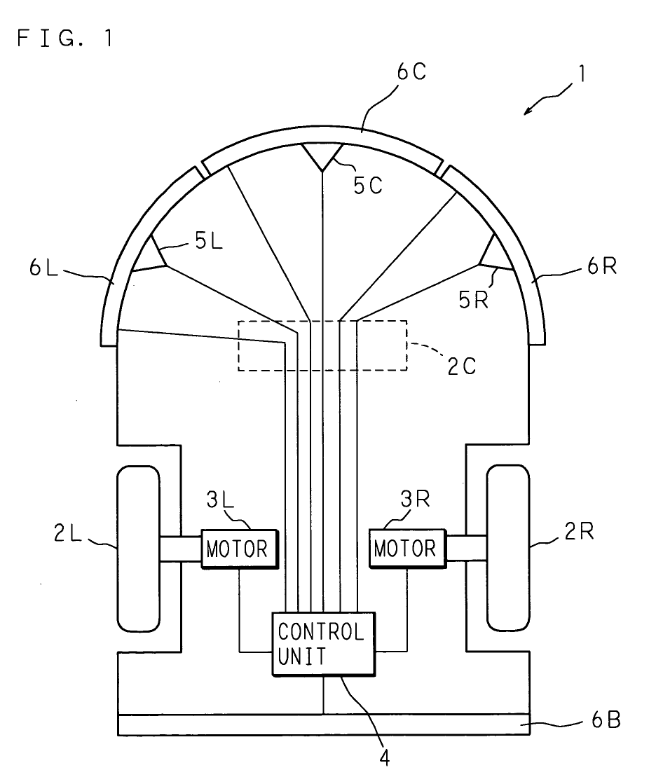

FIG. 1 is a block diagram showing an example of the schematic structure of an automotive movable body according to Embodiment 1 of the present invention. In FIG. 1, denoted at 1 is an automotive movable body, such as an automotive vacuum cleaner or an automotive lawn mower, which is used so as to move all over an area surrounded by a boundary such as a wall.

The automotive movable body 1 is composed of a pair of driven wheels 2L and 2R; a steering wheel 2C; motors 3L and 3R for driving the driven wheels 2L and 2R; a control unit 4 for controlling a drive of the motors; ultrasonic sensors 5L, 5C and 5R for detecting a wall, an obstacle or the like; and pressure sensors 6L, 6C, 6R and 6B for detecting a contact with a wall, an obstacle or the like.

FIG. 1 shows a state where the automotive movable body 1 is drawn in perspective from above a plane surface thereof and shows a left driven wheel 2L, a right driven wheel 2R and a steering wheel 2C. The axles of the left driven wheel 2L and the right driven wheel 2R are respectively connected with the motors 3L and 3R which function as actuators. The steering wheel 2C is not especially connected with driving force and is mounted rotatably on the bottom surface of the automotive mobile body 1 so that the direction thereof can be freely changed according to the moving direction of the automotive mobile body 1. It should be noted that, regarding the motor 3L for driving the left wheel, a clockwise rotation viewed from the axle to the driven wheel 2L is in a forward rotative direction and a counterclockwise rotation is in a backward rotative direction while, regarding the motor 3R for driving the right wheel, a counterclockwise rotation viewed from the axle to the driven wheel 2R is in a forward rotative direction and a clockwise rotation is in a backward rotative direction.

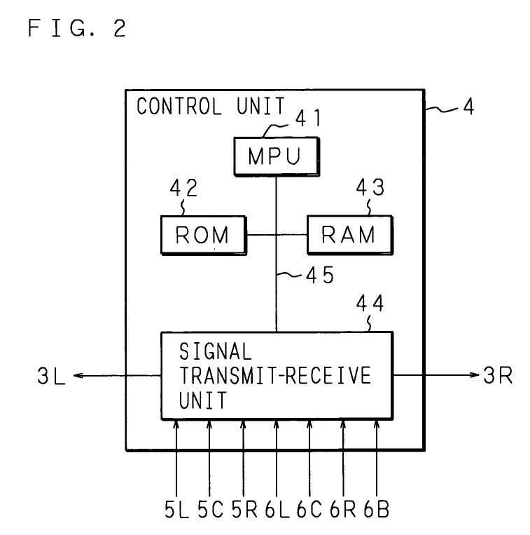

The control unit 4, which is a microprocessor, comprises at least an MPU 41, a ROM 42, a RAM 43 and a signal transmit-receive unit 44. FIG. 2 is a block diagram showing the structure of the control unit 4. The control unit 4 receives with the signal transmit-receive unit 44 a signal detected at each of the sensors 5L, 5C, 5R, 6L, 6C, 6R and 6B which will be described later. The received signals are inputted into the MPU 41 via an internal bus 45. The MPU 41 performs various calculation processes according to a process program stored in the ROM 42 and outputs to each of the motors 3L and 3R either a forward rotation indicating signal or a backward rotation indicating signal. The MPU 41 also calculates the coordinate value after moving with respect to a predetermined origin according to the numbers of revolutions of the motors 3L and 3R and stores the calculated coordinate value in the RAM 43.

The front portion of the automotive movable body 1 on the moving direction side is of a half-column shape and comprises an ultrasonic sensor 5L for detecting an object on the left, an ultrasonic sensor 5C for detecting an object in front and an ultrasonic sensor 5R for detecting an object on the right.

Each of the ultrasonic sensors 5L, 5C and 5R is composed of one ultrasonic transmitter and two ultrasonic receivers, wherein a reflected wave of an ultrasonic wave transmitted from the ultrasonic transmitter is received by each of the two ultrasonic receivers. The control unit 4 outputs a transmission indicating signal to the ultrasonic transmitter, so that the reflected wave received by the ultrasonic receiver is inputted as a signal. The state of an object to be detected, such as a position or motion, is calculated by the MPU 41 of the control unit 4.

In addition to the ultrasonic sensors, the pressure sensors 6L, 6C, 6R and 6B are provided at a bumper portion arranged at a marginal portion of the automotive movable body 1, as contact sensors respectively for left, front, right and back. When any of the pressure sensors 6L, 6C, 6R and 6B detects a pressure, a detected pressure value signal is transmitted to the control unit 4. In Embodiment 1, the pressure sensors 6L, 6C, 6R and 6B are used as auxiliary sensors.

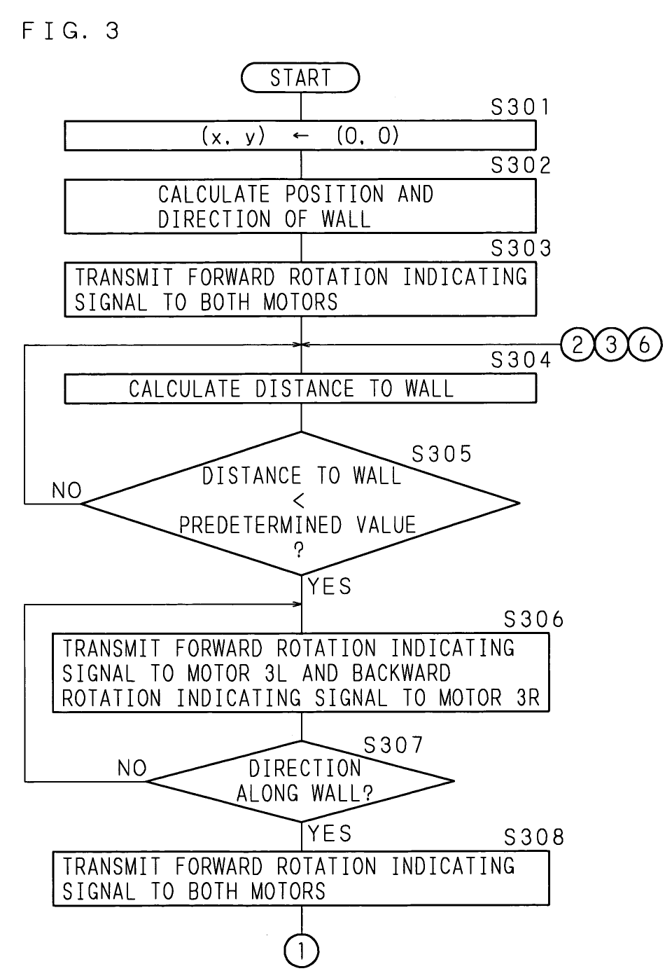

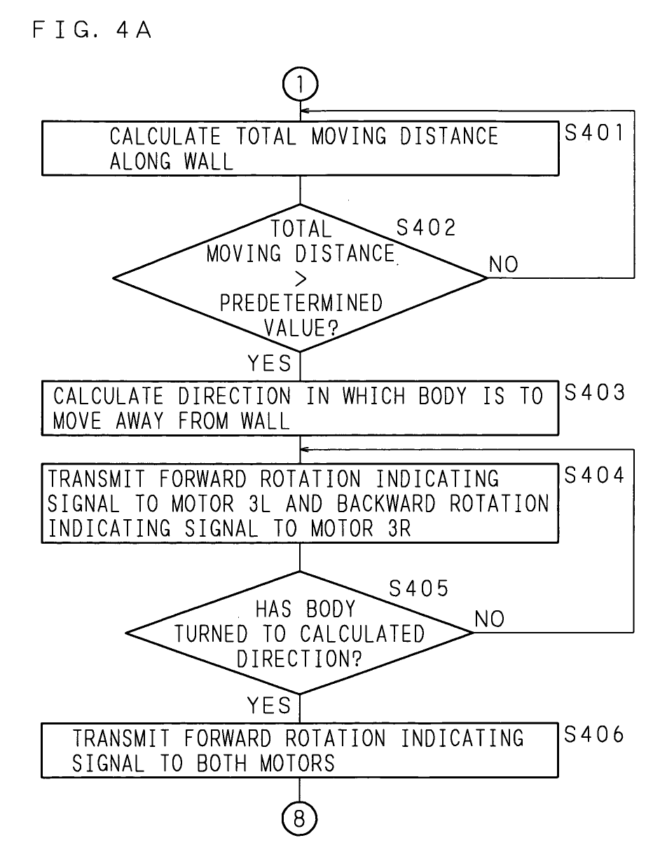

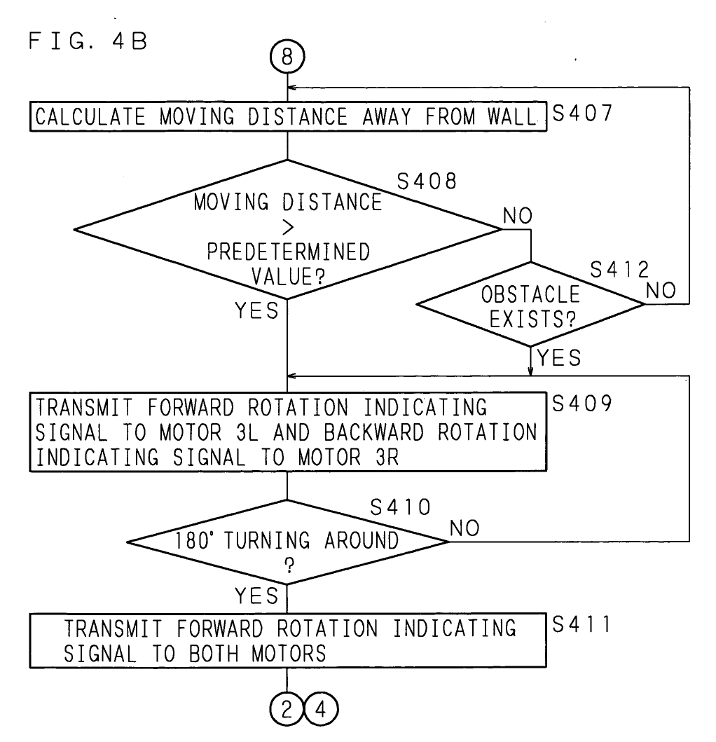

The following description will explain the operations of the automotive movable body 1 constructed as described above. FIGS. 3, 4A and 4B are flow charts showing the operational control procedure of the control unit 4 of the automotive movable body 1 according to Embodiment 1 of the present invention. FIGS. 3, 4A and 4B illustrate a case where the body moves in a clockwise direction.

When the automotive movable body 1 is located in an area surrounded by a wall to start moving, the control unit 4 detects the position of the nearest wall on the basis of input signals from the plurality of ultrasonic sensors 5L, 5C and 5R. In particular, the control unit 4 resets the position coordinate counter (x, y) of the RAM 43 to (0, 0) when a moving start instruction is issued so that the origin (0, 0) of coordinate axes specified with an x axis and a y axis in the area surrounded by a wall becomes a position where the automotive movable body 1 starts moving (step S301). The MPU 41 of the control unit 4 then increments or decrements the coordinate counter on the basis of the numbers of revolutions of the left and right driven wheels 2L and 2R which causes the following movement and stores the coordinate value (x, y) obtained during moving or after moving in the RAM 43.

The MPU 41 calculates the position and the direction of a wall lying in front on the basis of signals inputted from the ultrasonic sensors 5L, 5C and 5R (step S302) and transmits a forward rotation indicating signal to the motors 3L and 3R so as to cause straight moving toward the wall (step S303). The motors 3L and 3R rotate by the same number of revolutions in the forward rotative direction and the driven wheels 2L and 2R rotate by the same number of revolutions in the same direction, so that the automotive movable body 1 moves straight toward the wall.

The MPU 41 calculates a distance to a wall lying in front on the basis of signals inputted from the ultrasonic sensors 5L, 5C and 5R (step S304) and judges whether the calculated distance is smaller than a predetermined value or not (step S305). When the MPU 41 judges that the calculated distance is smaller than a predetermined value (step S305: YES), it is judged that the body has come close to the wall and the MPU 41 transmits a forward rotation indicating signal to the motor 3L and a backward rotation indicating signal to the motor 3R so that the body is turned to a direction along the wall (step S306). The motors 3L and 3R rotate by the same number of revolutions in the opposite directions and the driven wheels 2L and 2R rotate by the same number of revolutions in the opposite directions, so that the automotive movable body 1 turns to a direction along the wall.

When the MPU 41 judges that a direction to which the automotive movable body 1 has turned is a direction along the wall on the basis of signals inputted from the ultrasonic sensors 5L, 5C and 5R (step S307: YES), the MPU 41 transmits a forward rotation indicating signal to the motors 3L and 3R so that the body moves straight in a direction along the detected wall (step S308). The MPU 41 stores the coordinate value at the time of transmission of the forward rotation indicating signal to the motors 3L and 3R as a moving starting coordinate (x1, y1) in the RAM 43. The motors 3L and 3R fluctuates the number of revolutions in the forward rotative direction. Since the driven wheels 2L and 2R rotate while fluctuating the number of revolutions in the same direction, the automotive movable body 1 moves straight while keeping the distance to the wall within a predetermined range.

It should be noted that, in addition to transmitting a forward rotation indicating signal to the motors 3L and 3R, the MPU 41 can also transmit a signal for indicating the numbers of revolutions of the motors 3L and 3R. In this case, the distance between the automotive movable body 1 and the detected wall is calculated on the basis of a signal inputted from, for example, the ultrasonic sensor 5L and the distance between the automotive movable body 1 and the wall is subtracted from the calculated distance. When the MPU 41 judges that the subtracted value exceeds a predetermined range, the MPU 41 transmits a forward rotation indicating signal as well as a revolutions number indicating signal to the motors 3L and 3R so as to keep a distance to the detected wall.

In particular, when the value subtracted by the MPU 41 is a positive value and exceeds a predetermined range, the MPU 41 transmits a signal for instructing to make the number of revolutions of the motor 3L smaller than the number of revolutions of the motor 3R. When the value subtracted by the MPU 41 is a negative value and exceeds a predetermined range, the MPU 41 transmits a signal for instructing to make the number of revolutions of the motor 3R smaller than the number of revolutions of the motor 3L. In this manner, since the driven wheels 2L and 2R rotate while fluctuating the number of revolutions in the same direction, the automotive movable body 1 can move while keeping the distance to the wall within a predetermined range.

The MPU 41 calculates a total moved distance from the time of transmission of a forward rotation indicating signal to the motors 3L and 3R (step S401) and judges whether the calculated total moved distance is larger than a predetermined value which is preset or not (step S402).

In the course of moving, when the wall is inclined by a predetermined inclination, e.g. at a right angle, the control unit 4 controls the rotative directions of the motors 3L and 3R so as to modify the moving direction of the automotive movable body 1 in accordance with the inclination. The calculated moved distance is a total moved distance from the coordinate (x1, y1) of the position where moving in a direction along the wall is started to the coordinate (x2, y2) of the position where moving in a direction along the wall is completed.

When the MPU 41 judges that the calculated moved distance is larger than a predetermined value which is preset (step S402: YES), the MPU 41 calculates a direction in which the body is to move away from the wall (step S403) and transmits a forward rotation indicating signal to the motor 3L and a backward rotation indicating signal to the motor 3R (step S404). The motors 3L and 3R rotate by the same number of revolutions in the opposite directions and the driven wheels 2L and 2R rotate by the same number of revolutions in the opposite directions, so that the automotive movable body 1 turns to a direction calculated by the control unit 4.

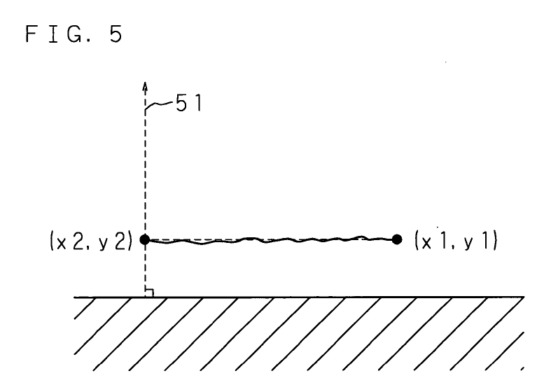

FIG. 5 is an explanatory view showing a method for calculating a direction in which the body is to move to go away from the wall in a case where a moving path between the coordinate (x1, y1) of the position where moving in a direction along the wall is started and the coordinate (x2, y2) of the position where moving in a direction along the wall is completed is a substantially straight line. As shown in FIG. 5, since the segment connecting the coordinate (x1, y1) of the position where moving in a direction along the wall is started with the coordinate (x2, y2) of the position where moving in a direction along the wall is completed is substantially parallel to the wall surface, the arrow 51 denoting a direction substantially perpendicular to the wall surface is calculated as a direction in which the body is to move to go away from the wall.

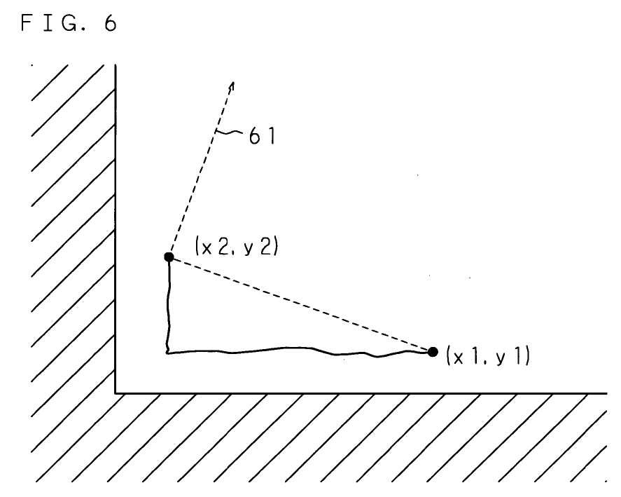

FIG. 6 is an explanatory view showing a method for calculating a direction in which the body is to move to go away from the wall in a case where a position inclined at a predetermined angle, e.g. four corners of a room, exists on the moving path between the coordinate (x1, y1) of the position where moving in a direction along the wall is started and the coordinate (x2, y2) of the position where moving in a direction along the wall is completed. As shown in FIG. 6, since the segment connecting the coordinate (x1, y1) of the position where moving in a direction along the wall is started with the coordinate (x2, y2) of the position where moving in a direction along the wall is completed has an angle θ1 represented by the following (formula 1) with respect to the wall surface, the arrow 61 denoting a direction having an angle θ2 orthogonal to the angle θ1 is calculated as a direction in which the body is to move away from the wall.
θ1=tan⁻¹((x2−x1)/(y2−y1)) (Formula 1)

The MPU 41 calculates a direction to which the body is to turn on the basis of the numbers of revolutions of the driven wheels 2L and 2R and judges whether the body has turned to a direction orthogonal to the segment connecting the coordinate (x1, y1) of the position where moving in a direction along the wall is started with the coordinate (x2, y2) of the position where moving in a direction along the wall is completed or not (step S405).

When the MPU 41 judges that the body has turned to a direction orthogonal to the segment connecting the coordinate (x1, y1) of the position where moving in a direction along the wall is started with the coordinate (x2, y2) of the position where moving in a direction along the wall is completed (step S405: YES), the MPU 41 transmits a forward rotation indicating signal to the motors 3L and 3R (step S406). The MPU 41 stores the coordinate value at the time of transmission of the forward rotation indicating signal to the motors 3L and 3R as a moving starting coordinate (x2, y2) in the RAM 43. The motors 3L and 3R rotate by the same number of revolutions in a forward rotative direction and the driven wheels 2L and 2R rotate by the same number of revolutions in the same direction, so that the automotive movable body 1 moves straight in a direction orthogonal to the segment connecting the coordinate (x1, y1) of the position where moving in a direction along the wall is started with the coordinate (x2, y2) of the position where moving in a direction along the wall is completed.

The MPU 41 calculates a moved distance from the time of transmission of a forward rotation indicating signal to the motors 3L and 3R, i.e. a distance in which the body moves away from the wall, (step S407) and judges whether the calculated moved distance is larger than a predetermined value which is preset or not (step S408).

When the MPU 41 judges that the calculated moved distance is larger than a predetermined value which is preset (step S408: YES), the MPU 41 transmits a forward rotation indicating signal to the motor 3L and a backward rotation indicating signal to the motor 3R so that the body goes back to a position where moving to go away in a predetermined direction is started (step S409). The motors 3L and 3R rotate the number of revolutions in the opposite directions and the driven wheels 2L and 2R rotate by the same number of revolutions in the opposite directions, so that the automotive movable body 1 turns around at an approximately 180°.

When the MPU 41 judges that the calculated moved distance is smaller than a predetermined value which is preset (step S408: NO), the MPU 41 confirms whether an obstacle exists or not on the basis of signals inputted from the ultrasonic sensors 5L, 5C and 5R (step S412). When the MPU 41 confirms the existence of an obstacle (step S412: YES), i.e. when an obstacle exists at a halfway point of a predetermined distance to cover, the MPU 41 transmits a forward rotation indicating signal to the motor 3L and a backward rotation indicating signal to the motor 3R so that the body goes back to a position where moving away in a predetermined direction is started (step S409). The motors 3L and 3R rotate by the same number of revolutions in the opposite directions and the driven wheels 2L and 2R rotate by the same number of revolutions in the opposite directions, so that the automotive movable body 1 turns around at an approximately 180°.

The MPU 41 calculates a direction to which the body is to turn on the basis of the numbers of revolutions of the driven wheels 2L and 2R and judges whether the body has turned around toward a coordinate (x2, y2) of the position where straight moving away from the wall is started or not, i.e. whether the body has turned around at 180° or not (step S410). Judging that the body has turned around at an approximately 180° (step S410: YES), the MPU 41 transmits a forward rotation indicating signal to the motors 3L and 3R (step S411). The motors 3L and 3R rotate by the same number of revolutions in the forward rotative direction and the driven wheels 2L and 2R rotate by the same number of revolutions in the same direction, so that the automotive movable body 1 moves straight toward the coordinate (x2, y2) of the position where straight moving away from the wall is started.

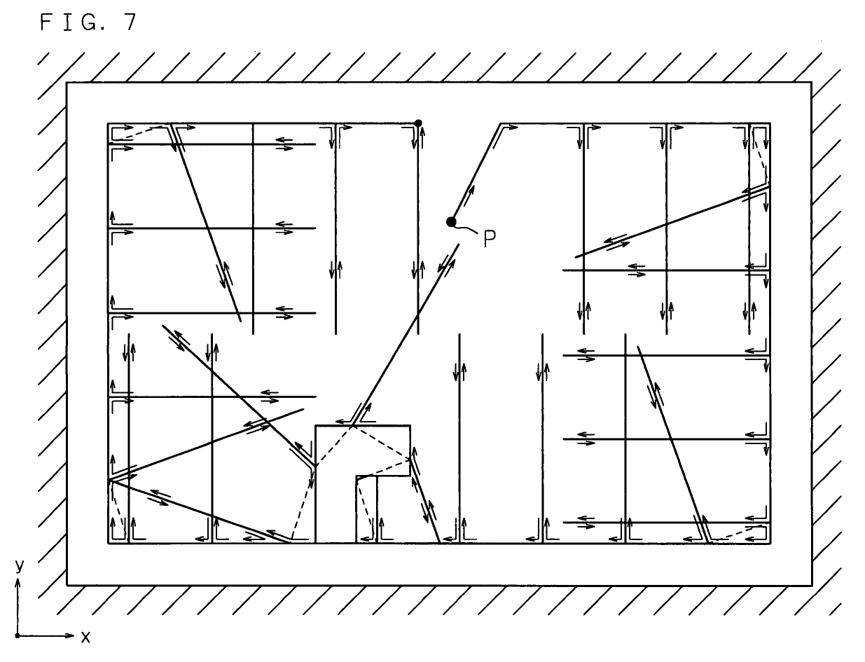

From then on, the process goes back to the step S304 and the control unit 4 controls the operations of the automotive movable body 1 so as to move substantially in a zigzag as described above. FIG. 7 is a view showing a moving path of the automotive movable body 1 which is located at a moving starting position P. As shown in FIG. 7, the automotive movable body 1 which has moved away from a wall surely moves along a wall after going back to a position where moving away from the wall is started, so that the body moves along the entire length of the inner surface of the wall. In this manner, the body can continue moving without coming to a stand even when a dead end is formed at a portion of the wall as shown in FIG. 7, for example.

As described above, with this Embodiment 1, the body can move along the substantially entire length of the inner surface of the wall no matter what shape the wall has and can move to the entire area surrounded by the wall excluding an area where an obstacle exists no matter what shape the obstacle existing within the area has.

### Embodiment 2

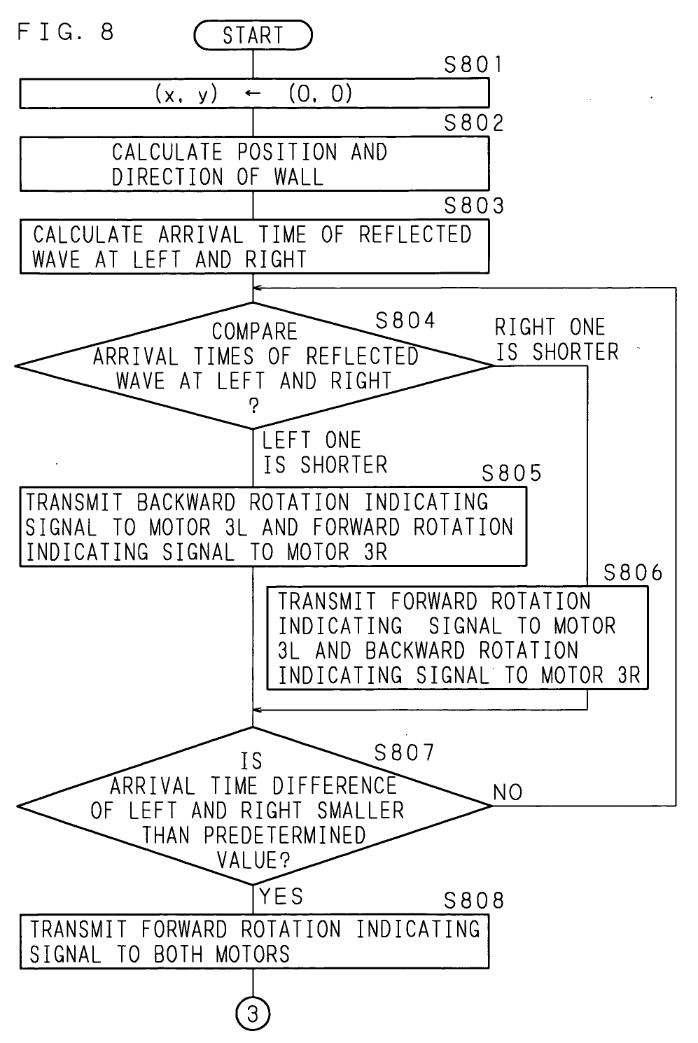

The following description will explain an automotive movable body 1 according to Embodiment 2 of the present invention. FIG. 8 is a flow chart showing a part of the operational control procedure of a control unit 4 of the automotive movable body 1 according to Embodiment 2 of the present invention. FIG. 8 illustrates a case where the body moves in a clockwise direction. It should be noted that the automotive movable body 1 according to Embodiment 2 of the present invention is the same as Embodiment 1 in construction and the detailed explanation thereof will be omitted by appending the same codes.

When the automotive movable body 1 is located in an area surrounded by a wall to start moving, the control unit 4 detects the position of the nearest surface of the wall on the basis of input signals from a plurality of sensors 5L, 5C and 5R. In particular, the MPU 41 resets the position coordinate counter (x, y) of the RAM 43 to (0, 0) when a moving start instruction is issued so that the origin (0, 0) of coordinate axes specified with an x axis and a y axis in the area surrounded by a wall becomes a position where the automotive movable body 1 starts moving (step S801). The MPU 41 then increments or decrements the coordinate counter on the basis of the numbers of revolutions of the left and right driven wheels 2L and 2R which causes the following movement and stores the coordinate value (x, y) obtained during moving or after moving in the RAM 43.

The MPU 41 calculates the position and the direction of a wall standing in front on the basis of signals inputted from the ultrasonic sensors 5L, 5C and 5R (step S802) and calculates the curtate distance and the direction of the wall. That is, the body moves in a manner that the arrival times of reflected waves from the ultrasonic sensors 5L and 5R which are provided at the right and left of the automotive movable body 1 becomes substantially uniform irrespective of how the automotive movable body 1 is located in an area surrounded by a wall.

In particular, the MPU 41 calculates the arrival time of the reflected wave on the basis of signals inputted from the ultrasonic sensors 5L and 5R which are provided at the left and right of the automotive movable body 1 (step S803). The MPU 41 compares the arrival times of reflected waves of the two sensors (step S804), and when the arrival time of a reflected wave of an ultrasonic sensor 5L (5R) which is provided at the left (right) of the automotive movable body 1 is shorter, it is judged that the body is moving in a direction veered to the right (left) with respect to a direction perpendicular to the wall surface. Consequently, the MPU 41 transmits a backward (forward) rotation indicating signal to the motor 3L and a forward (backward) rotation indicating signal to the motor 3R (steps S805, S806), so that the automotive movable body 1 turns around.

While the automotive movable body 1 is turning around, the MPU 41 continuously calculates a difference between the arrival times of reflected waves on the basis of signals inputted from the ultrasonic sensors 5L and 5R which are provided at the left and right and judges whether the calculated difference between the arrival times of reflected waves is smaller than a predetermined value or not (step S807). When the MPU 41 judges that the difference between the arrival times of reflected waves calculated on the basis of the signals inputted from the ultrasonic sensors 5L and 5R is smaller than a predetermined value (step S807: YES), the MPU 41 transmits a forward rotation indicating signal to the motors 3L and 3R (step S808). In this manner, the automotive movable body 1 can move in a direction perpendicular to the wall surface irrespective of how the body is located in the area surrounded by a wall at the time of start of moving, so that the calculation error of the coordinate value to be generated later can be minimized.

From then on, it should be understood that the control unit 4 can bring about the same effect as Embodiment 1 by executing the same processes as those after the step S304 in FIG. 3.

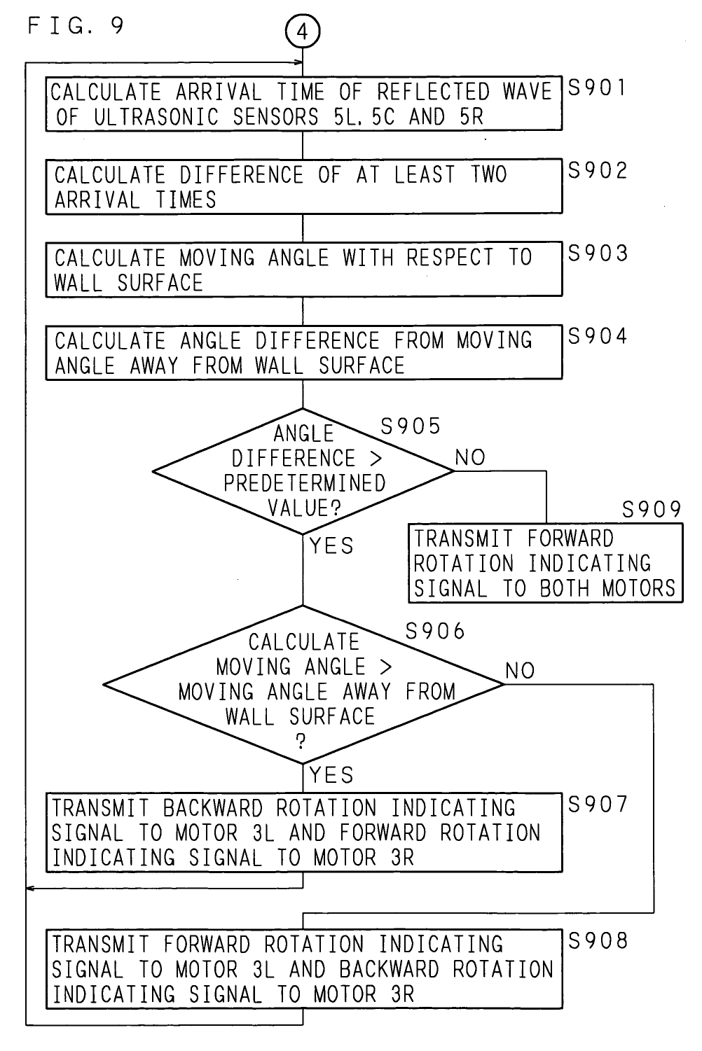

Moreover, such a method for controlling the moving direction can be also applied to a case where the automotive movable body 1 moves toward a wall after turning around at an approximately 180°. After the step S411 in FIG. 4B, as shown in FIG. 9, the MPU 41 calculates the arrival time of reflected waves on the basis of signals inputted from the ultrasonic sensors 5L, 5C and 5R (step S901). The MPU 41 calculates an arrival time difference of reflected waves on the basis of at least two signals of signals inputted from the three ultrasonic sensors 5L, 5C and 5R (step S902) and calculates a moving angle with respect to the wall surface according to the calculated arrival time difference of reflected waves (step S903). The arrival time difference of reflected wave is calculated on the basis of at least two signals because there are cases where the existence of a wall cannot be detected by either a left or right ultrasonic sensor 5L or 5R depending on an angle with respect to the wall.

The MPU 41 calculates a difference between the calculated moving angle and an angle of straight moving away from the wall with respect to the wall (step S904) and judges whether a difference between the two angles is larger than a predetermined value or not (step S905). When the MPU 41 judges that the difference between the two angles is larger than a predetermined value (step S905: YES), the MPU 41 judges whether the calculated moving angle is larger than the angle of straight moving away from the wall with respect to the wall or not (step S906).

When the MPU 41 judges that the calculated moving angle is larger than the angle of straight moving away from the wall with respect to the wall (step S906: YES), it is judged that the body is inclined to the right with respect to an angle at which the body is supposed to move and the MPU 41 transmits a backward rotation indicating signal to the motor 3L and a forward rotation indicating signal to the motor 3R (step S907), so that the automotive movable body 1 turns around.

When the MPU 41 judges that the calculated moving angle is smaller than the angle of straight moving away from the wall with respect to the wall (step S906: NO), it is judged that the body is inclined to the left with respect to an angle at which the body is supposed to move and the MPU 41 transmits a forward rotation indicating signal to the motor 3L and a backward rotation indicating signal to the motor 3R (step S908) so that the automotive movable body 1 turns around.

While the automotive movable body 1 is turning around, the MPU 41 continuously calculates a difference between the arrival times of reflected waves on the basis of at least two signals of signals inputted from the three ultrasonic sensors 5L, 5C and 5R and judges whether a difference between the angles with respect to the wall calculated based on the calculated difference between the arrival times of reflected waves is smaller than a predetermined value or not. When the MPU 41 judges that the difference between the two angles is smaller than a predetermined value (step S905: NO), the MPU 41 transmits a forward rotation indicating signal to the motors 3L and 3R (step S909). In this manner, the automotive movable body 1 can correct a moving angle to a proper angle even when the roughness of the floor surface or the like causes the body to move at an angle different from an angle of moving away from the wall and the automotive movable body 1 can go back to a position where moving away from the wall is started with high accuracy, so that the automotive movable body 1 can move substantially in a zigzag in the area along the entire length of the surface of the wall.

As described above, with this Embodiment 2, even when it is difficult to move straight toward the wall detected first by a sensor due to the floor surface state, such as roughness of the floor surface, the body can move toward the wall while correcting the moving direction according to the detection results of a plurality of sensors, so that the movable body can move while judging the position of the movable body correctly without using position measuring means which is expensive and of high precision.

Moreover, when it is difficult to move straight toward the wall due to the flow surface state, such as roughness of the floor surface, after going away from the wall and turning around, the body can move so as to go back to a position where the body has started moving away from the wall correctly while correcting the moving direction according to the detection results of a plurality of sensors, so that the movable body can move while judging the position of the movable body correctly without using position measuring means which is expensive and of high precision.

### Embodiment 3

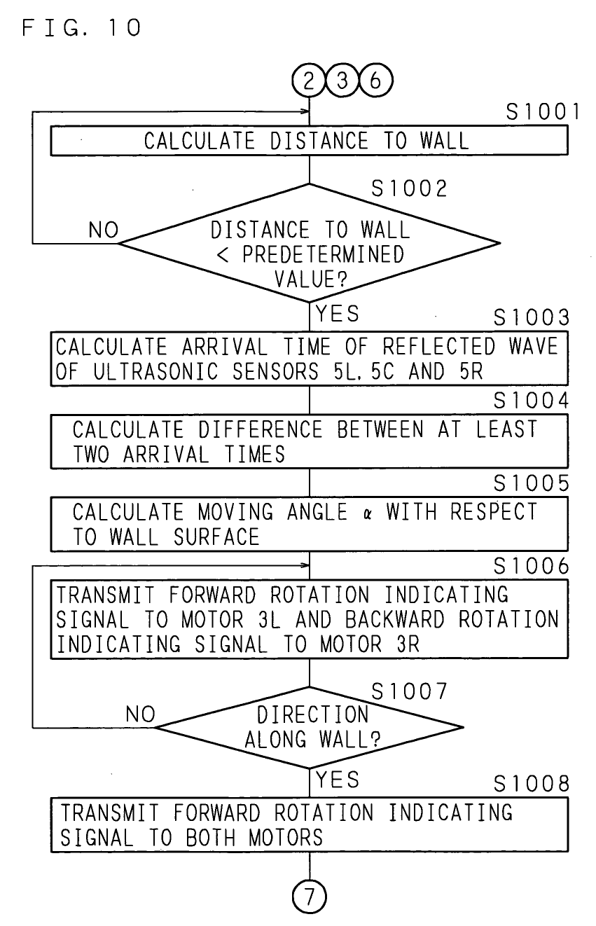

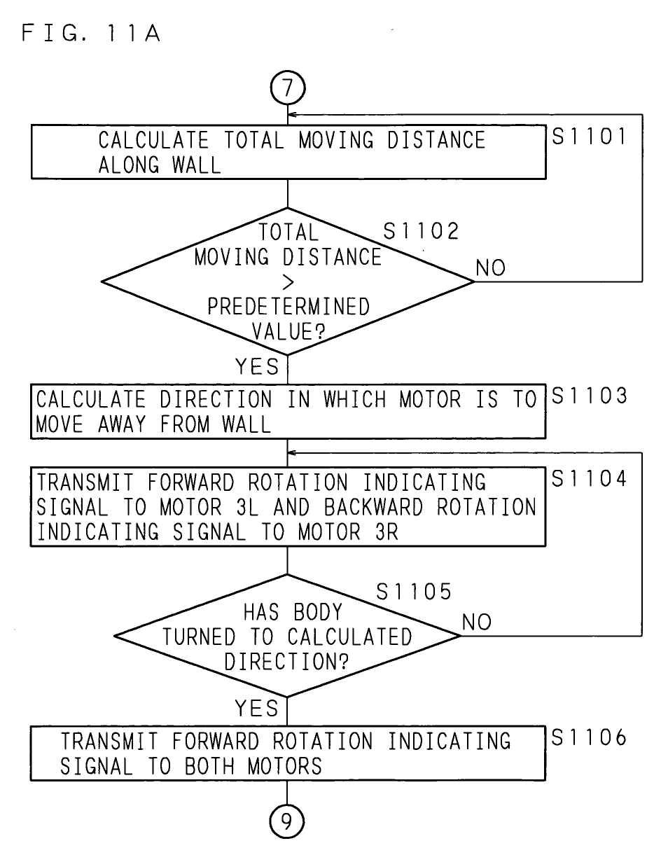

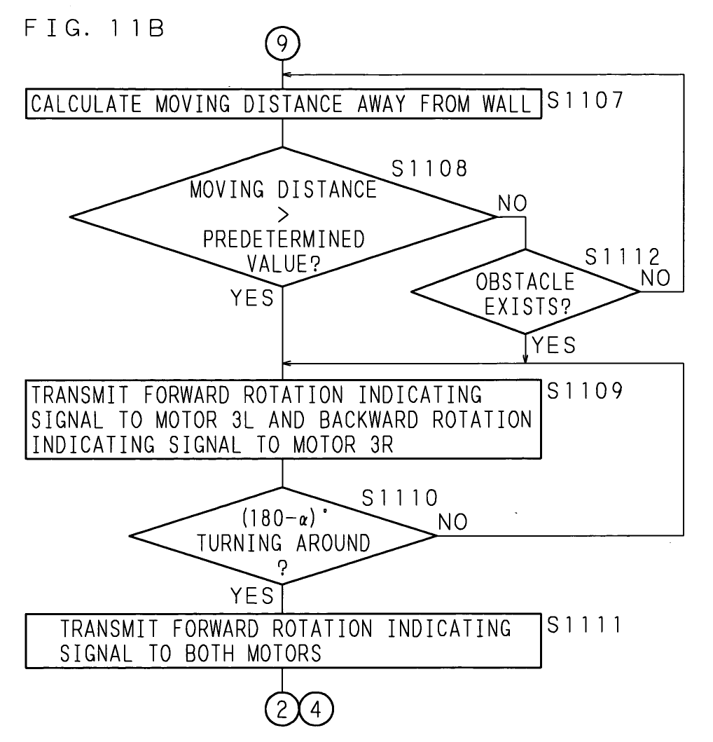

Embodiment 3, which will explain an automotive movable body 1 according to Embodiment 3 of the present invention in the following description, is characterized in the moving control procedure to be performed after the automotive movable body 1 turns around at an approximately 180° and moves toward the wall. FIGS. 10, 11A and 11B are flow charts showing a part of the operational control procedure of a control unit 4 of the automotive movable body 1 according to Embodiment 3 of the present invention. FIGS. 10, 11A and 11B illustrate a case where the body moves in a clockwise direction. It should be noted that the automotive movable body 1 according to Embodiment 3 of the present invention is the same as Embodiment 1 in construction and the detailed explanation thereof will be omitted by appending the same codes.

The MPU 41 calculates the distance to a wall lying in front on the basis of signals inputted from ultrasonic sensors 5L, 5C and 5R (step S1001) and judges whether the calculated distance is smaller than a predetermined value or not (step S1002).

When the MPU 41 judges that the calculated distance is smaller than a predetermined value (step S1002: YES), it is judged that the body has come close to a wall and the MPU 41 calculates the arrival times of reflected waves on the basis of signals inputted from the ultrasonic sensors 5L, 5C and 5R (step S1003).

The MPU 41 calculates an arrival time difference of reflected wave on the basis of at least two signals of signals inputted from the three ultrasonic sensors 5L, 5C and 5R (step S1004), calculates a moving angle a with respect to the normal direction of the wall surface at the time of arrival at the wall surface according to the calculated arrival time difference of reflected waves (step S1005) and stores the moving angle a in the RAM 43. The arrival time difference of reflected waves is calculated on the basis of at least two signals because there are cases where the existence of a wall cannot be detected with either a left or right ultrasonic sensor 5L or 5R depending on a moving angle with respect to the wall. The moving angle a assumes that, the normal direction of the wall surface is 0° and a moving direction (rightward in this embodiment which employs moving in a clockwise direction) is positive.

The MPU 41 transmits a forward rotation indicating signal to the motor 3L and a backward rotation indicating signal to the motor 3R so that the body turns to a direction along the wall (step S1006). The motors 3L and 3R rotate by the same number of revolutions in the opposite directions and the driven wheels 2L and 2R rotate by the same number of revolutions in the opposite directions, so that the automotive movable body 1 turns to a direction along the wall.

When the MPU 41 judges that a direction to which the automotive movable body 1 has turned is a direction along the wall on the basis of signals inputted from the ultrasonic sensors 5L, 5C and 5R (step S1007: YES), the MPU 41 transmits a forward rotation indicating signal to the motors 3L and 3R so that the body moving straight in a direction along the detected wall (step S1008). The MPU 41 stores the coordinate value at the time of transmission of the forward rotation indicating signal to the motors 3L and 3R as a moving starting coordinate (x1, y1) in the RAM 43. The motors 3L and 3R fluctuate the numbers of revolutions in the forward rotative direction. Since the driven wheels 2L and 2R rotate in the same direction while fluctuating the numbers of revolutions, the automotive movable body 1 moves straight while keeping the distance to the wall within a certain range.

It should be noted that, in addition to transmitting a forward rotation indicating signal to the motors 3L and 3R, the MPU 41 also can transmit a signal for indicating the numbers of revolutions of the motors 3L and 3R, similarly to Embodiment 1. In this manner, since the driven wheels 2L and 2R rotate in the same direction while fluctuating the numbers of revolutions, the automotive movable body 1 can move straight while keeping the distance to the wall within a certain range.

The MPU 41 calculates the total moved distance from the time of transmission of a forward rotation indicating signal to the motors 3L and 3R (step S1101) and judges whether the calculated total moved distance is larger than a predetermined value which is preset or not (step S1102).

In the course of moving, when the wall is bent at a predetermined angle, e.g. at a right angle, the control unit 4 controls the rotative directions of the motors 3L and 3R so as to modify the moving direction of the automotive movable body 1 in accordance with the angle of the bend. The calculated moved distance is a total moved distance from the coordinate (x1, y1) of the position where moving in a direction along the wall is started to the coordinate (x2, y2) of the position where moving in a direction along the wall is completed.

When the MPU 41 judges that the calculated moved distance is larger than a predetermined value which is preset (step S1102: YES), the MPU 41 calculates a direction in which the motor is to move to go away from the wall (step S1103) and transmits a forward rotation indicating signal to the motor 3L and a backward rotation indicating signal to the motor 3R (step S1104). The motors 3L and 3R rotate by the same number of revolutions in the opposite directions and the driven wheels 2L and 2R rotate by the same number of revolutions in the opposite directions, so that the automotive movable body 1 turns to a direction calculated by the control unit 4.

The MPU 41 calculates a direction to which the body is to turn on the basis of the numbers of revolutions of the driven wheels 2L and 2R and judges whether the body has turned to a direction orthogonal to the segment connecting the coordinate (x1, y1) of the position where moving in a direction along the wall is started with the coordinate (x2, y2) of the position where moving in a direction along the wall is completed or not (step S1105).

When the MPU 41 judges that the body has turned to a direction orthogonal to the segment connecting the coordinate (x1, y1) of the position where moving in a direction along the wall is started with the coordinate (x2, y2) of the position where moving in a direction along the wall is completed (step S1105: YES), the MPU 41 transmits a forward rotation indicating signal to the motors 3L and 3R (step S1106). The MPU 41 stores the coordinate value at the time of transmission of the forward rotation indicating signal to the motors 3L and 3R as a moving starting coordinate (x2, y2) in the RAM 43. The motors 3L and 3R rotate by the same number of revolutions in the forward rotative direction and the driven wheels 2L and 2R rotate by the same number of revolutions in the same direction, so that the automotive movable body 1 moves straight in a direction orthogonal to the segment connecting the coordinate (x1, y1) of the position where moving in a direction along the wall is started with the coordinate (x2, y2) of the position where moving in a direction along the wall is completed.

The MPU 41 calculates a moved distance from the time of transmission of a forward rotation indicating signal to the motors 31 and 3R, i.e. a distance of moving away from the wall, (step S1107) and judges whether the calculated moved distance is larger than a predetermined value which is preset or not (step S1108).

When the MPU 41 judges that the calculated moved distance is larger than a predetermined value which is preset (step S1108: YES), the MPU 41 transmits a forward rotation indicating signal to the motor 3L and a backward rotation indicating signal to the motor 3R so that the body goes back to a position where moving to go away in a predetermined direction is started (step S1109). The motors 3L and 3R rotate by the same number of revolutions in the opposite directions and the driven wheels 2L and 2R rotate by the same number of revolutions in the opposite directions, so that the automotive movable body 1 turns around at an approximately 180°.

When the MPU 41 judges that the calculated moved distance is smaller than a predetermined value which is preset (step S1108: NO), the MPU 41 confirms whether an obstacle exists or not on the basis of signals inputted from the ultrasonic sensors 5L, 5C and 5R (step S1112). When the MPU 41 confirms the existence of an obstacle (step S1112: YES), i.e. when an obstacle exists at a halfway point of a predetermined distance to cover, the MPU 41 transmits a forward rotation indicating signal to the motor 3L and a backward rotation indicating signal to the motor 3R so that the body goes back to a position where moving to go away in a predetermined direction is started (step S1109). The motors 3L and 3R rotate by the same number of revolutions in the opposite directions and the driven wheels 2L and 2R rotate by the same number of revolutions in the opposite directions, so that the automotive movable body 1 turns around at an approximately 180°.

The MPU 41 calculates a direction to which the body is to turn on the basis of the numbers of revolutions of the driven wheels 2L and 2R and judges whether the body has turned around to an angle which is obtained by subtracting an angle α stored in the RAM 43 from 180° or not (step S1110). Judging that the body has turned around to an angle which is obtained by subtracting the angle α from 180° (step S1110: YES), the MPU 41 transmits a forward rotation indicating signal to the motors 3L and 3R (step S1111). The motors 3L and 3R rotate by the same number of revolutions in the forward rotative direction and the driven wheels 2L and 2R rotate by the same number of revolutions in the same direction, so that the automotive movable body 1 moves straight toward the coordinate (x2, y2) of a position where straight moving away from the wall is started.

From then on, the process goes back to the step S1001 and the control unit 4 controls the operations of the automotive movable body 1 so as to move substantially in a zigzag as described above.

As described above, with this Embodiment 3, even when it is difficult to move straight toward the wall due to the floor surface state, such as roughness of the floor surface, after going away from the wall and turning around, a moving direction at the time of returning to the wall is calculated on the basis of detection results of a plurality of sensors and the turning around direction can be corrected according to the calculated moving direction for moving toward the wall after turning around next, so that the movable body can go back to a position where it has moved away from the wall without using position measuring means which is expensive and of high precision.

### Embodiment 4

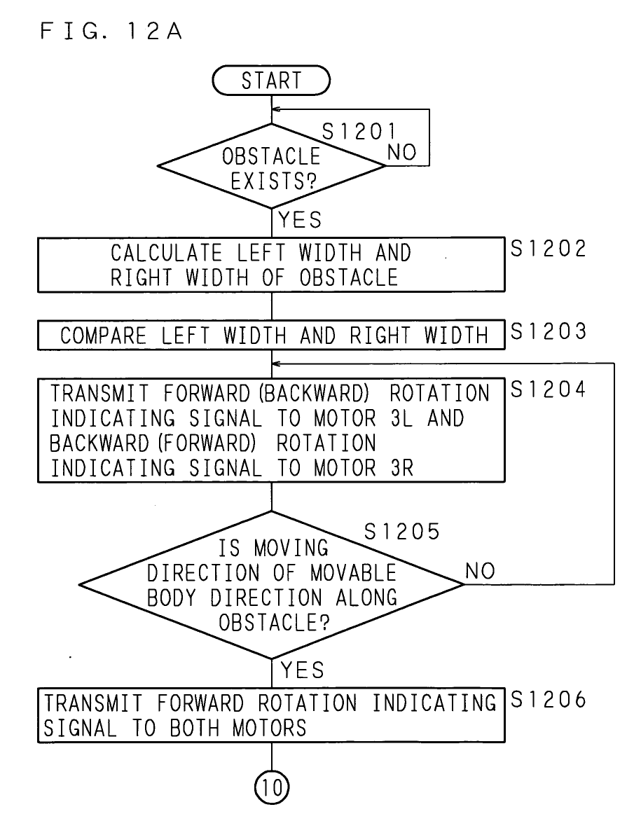

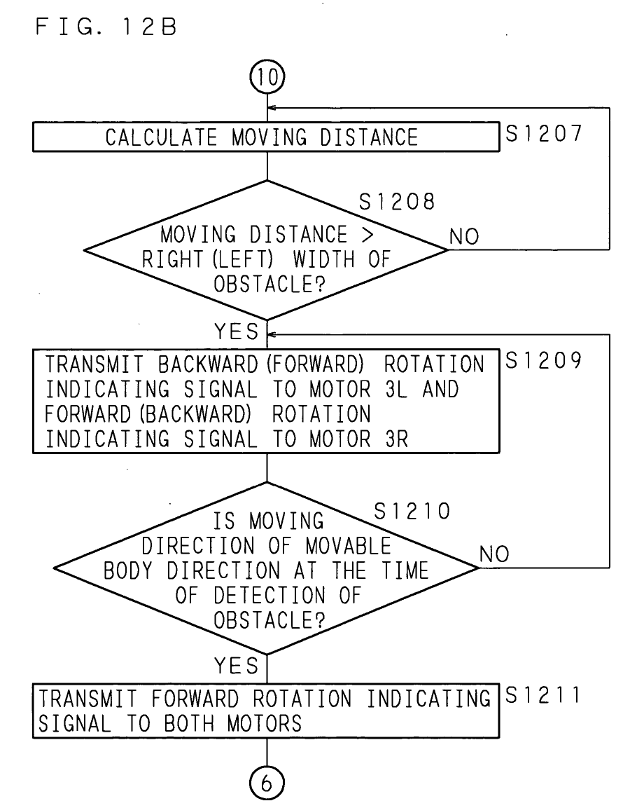

The following description will explain an automotive movable body 1 according to Embodiment 4 of the present invention. FIGS. 12A and 12B are flow charts showing a part of the operational control procedure of a control unit 4 of the automotive movable body 1 according to Embodiment 4 of the present invention. FIGS. 12A and 12B illustrate a case where the body moves in a clockwise direction. It should be noted that the automotive movable body 1 according to Embodiment 4 of the present invention is the same as Embodiment 1 in construction and the detailed explanation thereof will be omitted by appending the same codes.

The operational control procedure of the control unit 4 of the automotive movable body 1 in this Embodiment 4 is the same as that in FIGS. 3 and 4. This Embodiment 4 explains the process procedure of a case where an obstacle is detected during moving after the step S411 in FIG. 4B.

The MPU 41 judges whether an obstacle exists in front or not on the basis of signals inputted from ultrasonic sensors 5L, 5C and 5R (step S1201). Judging that an obstacle exists, the MPU 41 judges in which direction the body can move round at the shorter distance on the basis of signals inputted from the left and right ultrasonic sensors 5L and 5R.

To be more specific, the MPU 41 calculates the left width and the right width of the obstacle in a direction perpendicular to the moving direction on the basis of signals inputted from the left and right ultrasonic sensors 5L and 5R (step S1202) and compares the left width and the right width of the obstacle (step S1203). The MPU 41 transmits a driving signal so that the body moves round to the right when it is judged that the right width is the shorter, or to the left when it is judged that the left width is the shorter.

For example, judging that the right (left) width is the shorter, the MPU 41 transmits a forward (backward) rotation indicating signal to the motor 3L and a backward (forward) rotation indicating signal to the motor 3R (step S1204), so that the automotive movable body 1 turns around to the right (left).

While the automotive movable body 1 is turning around, the MPU 41 calculates the direction of the automotive movable body 1 on the basis of at least two signals of signals inputted from the three ultrasonic sensors 5L, 5C and 5R and judges whether the calculated direction of the automotive movable body 1 is a direction along the detected obstacle or not (step S1205). When the MPU 41 judges that the calculated direction of the automotive movable body 1 is the direction along the detected obstacle (step S1205: YES), the MPU 41 transmits a forward rotation indicating signal to the motors 3L and 3R (step S1206).

The MPU 41 calculates the moved distance on the basis of the numbers of revolutions of the driven wheels 2L and 2R (step S1207) and judges whether the calculated moved distance has been up to the right (left) width or not (step S1208). When the MPU 41 judges that the calculated moved distance has been up to the right (left) width (step S1208: YES), the MPU 41 transmits a backward (forward) rotation indicating signal to the motor 3L and a forward (backward) rotation indicating signal to the motor 3R (step S1209), so that the automotive movable body 1 turns around to the left (right).

While the automotive movable body 1 is turning around, the MPU 41 calculates the direction of the automotive movable body 1 on the basis of at least two signals of signals inputted from the three ultrasonic sensors 5L, 5C and 5R and judges whether the calculated direction of the automotive movable body 1 is the moving direction at the time of detection of the obstacle or not (step S1210). When the MPU 41 judges that the calculated direction of the automotive movable body 1 is the moving direction at the time of detection of the obstacle (step S1210: YES), the MPU 41 transmits a forward rotation indicating signal to the motors 3L and 3R (step S1211).

In this manner, even when an obstacle exists, the automotive movable body 1 can move round the obstacle and can move substantially in a zigzag within an area along the entire length of the wall surface by going back to the position where moving away from the wall is started.

As described above, with this Embodiment 4, even when an obstacle exists in the course of going back to the wall, the body can avoid the obstacle by moving round and can move along the substantially entire length of the inner surface of the wall by going back to the position where moving away from the wall is started, so that the body can move to the entire area excluding an area where the obstacle exists.

It should be noted that, though the Embodiments 1 to 4 explain a case of performing moving control that combines straight movement and rotational movement at a position by rotating the motors 3L and 3R by the same number of revolutions in order to simplify the explanation, the present invention is not limited to this but the body may be stopped, or the same effect can be expected in a method for controlling fluctuation of the numbers of revolutions of the driven wheels using, for example, an encoder and fluctuating the turning radius of the movable body to control movement including rotational movement.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An automotive movable body comprising:
a driven wheel;
an actuator for driving the driven wheel;
a sensor for detecting an object which exists in the vicinity;
a control unit for controlling an operation of the driven wheel according to a detection result of the sensor; and
a moved distance calculating unit for calculating a moved distance from a moving starting position,
the control unit comprising:
first driving signal outputting means for outputting to the actuator a driving signal capable of causing the body to move along an object;
first judging means for judging whether the distance calculated by the moved distance calculating unit is up to a first distance or not;
second driving signal outputting means for outputting to the actuator a driving signal capable of causing the body to move in a direction which intersects with a segment connecting a position before moving with a position after moving, when the first judging means judges that the distance is up to the first distance;
second judging means for judging whether the distance calculated by the moved distance calculating unit is up to a second distance or not; and
third driving signal outputting means for outputting to the actuator a driving signal capable of causing the body to turn around at approximately 180°, when the second judging means judges that the distance is up to the second distance or when the sensor detects an object.

2. The automotive movable body according to claim 1, further comprising:
fourth driving signal outputting means for outputting to the actuator a driving signal capable of causing the body to move toward an object detected by the sensor after moving is started;
distance calculating means for calculating a distance to a detected object, when the sensor detects the object; and
third judging means for judging whether the distance calculated by the distance calculating means is shorter than a predetermined value or not.

3. An automotive movable body comprising:
a driven wheel;
an actuator for driving the driven wheel;
a sensor for detecting an object which exists in the vicinity;
a control unit for controlling an operation of the driven wheel according to a detection result of the sensor; and
a moved distance calculating unit for calculating a moved distance from a moving starting position,
the control unit comprising a processor capable of performing the following operations of
outputting to the actuator a driving signal capable of causing the body to move along an object;
judging whether the distance calculated by the moved distance calculating unit is up to a first distance or not;
outputting to the actuator a driving signal capable of causing the body to move in a direction which intersects with a segment connecting a position before moving with a position after moving, when it is judged that the distance is up to the first distance;
judging whether the distance calculated by the moved distance calculating unit is up to a second distance or not; and
outputting to the actuator a driving signal capable of causing the body to turn around at approximately 180°, when it is judged that the distance is up to the second distance or when the sensor detects an object.

4. The automotive movable body according to claim 3, wherein
the processor is further capable of performing the following operations of:
outputting to the actuator a driving signal capable of causing the body to move toward an object detected by the sensor after moving is started;
calculating a distance to a detected object, when the sensor detects the object; and
judging whether the calculated distance is shorter than a predetermined value or not.

5. The automotive movable body according to claim 4, comprising a plurality of sensors, wherein
the processor is further capable of performing the following operations of:
calculating a moving direction with respect to an object on the basis of a detection result of the plurality of sensors, when it is judged that the distance to the detected object is longer than a predetermined value;
judging whether the calculated moving direction differs from a normal direction of a surface of the object detected on the basis of detection results of the plurality of sensors or not; and
correcting a control signal to be sent to the actuator according to a difference between the calculated moving direction and the normal direction of the surface of the detected object, when it is judged that the calculated moving direction differs from the normal direction of the surface of the detected object.

6. The automotive movable body according to claim 4, comprising a plurality of sensors, wherein
the processor is further capable of performing the following operations of:
calculating a moving direction with respect to an object on the basis of detection results of the plurality of sensors, when it is judged that the distance to the detected object is shorter than a predetermined value; and
storing the calculated moving direction, wherein
the processor outputs to the actuator a driving signal having a corrected turning around direction according to the stored moving direction.

7. The automotive movable body according to claim 4, comprising a plurality of sensors, wherein
the processor is further capable of performing the following operations of:
calculating a moving direction with respect to an object on the basis of detection results of the plurality of sensors, when it is judged that the distance to the detected object is longer than a predetermined value;
judging whether the calculated moving direction differs from a moving direction specified by the sent driving signal or not; and
correcting a control signal to be sent to the actuator according to a difference between the two moving directions, when it is judged that two moving directions differ from each other.

8. The automotive movable body according to claim 5, comprising a plurality of sensors, wherein
the processor is further capable of performing the following operations of:
calculating a moving direction with respect to an object on the basis of detection results of the plurality of sensors, when it is judged that the distance to the detected object is longer than a predetermined value;
judging whether the calculated moving direction differs from a moving direction specified by the sent driving signal or not; and
correcting a control signal to be sent to the actuator according to a difference between the two moving directions, when it is judged that two moving directions differ from each other.

9. The automotive movable body according to claim 6, comprising a plurality of sensors, wherein
the processor is further capable of performing the following operations of:
calculating a moving direction with respect to an object on the basis of detection results of the plurality of sensors, when it is judged that the distance to the detected object is longer than a predetermined value;
judging whether the calculated moving direction differs from a moving direction specified by the sent driving signal or not; and
correcting a control signal to be sent to the actuator according to a difference between the two moving directions, when it is judged that two moving directions differ from each other.

10. The automotive movable body according to claim 4, wherein the processor is further capable of performing the following operations of:
calculating a moved distance before turning around covered before a driving signal capable of causing turning around at approximately 180° is sent to the actuator;
calculating a moved distance after turning around;
judging whether the moved distance after turning around is shorter than the moved distance before turning around or not, when the sensor detects the existence of an object; and
outputting to the actuator a driving signal capable of avoiding the detected object, when it is judged that the moved distance after turning around is shorter than the moved distance before turning around.

11. The automotive movable body according to claim 5, wherein the processor is further capable of performing the following operations of:
calculating a moved distance before turning around covered before a driving signal capable of causing turning around at approximately 180° is sent to the actuator;
calculating a moved distance after turning around;
judging whether the moved distance after turning around is shorter than the moved distance before turning around or not, when the sensor detects the existence of an object; and
outputting to the actuator a driving signal capable of avoiding the detected object, when it is judged that the moved distance after turning around is shorter than the moved distance before turning around.

12. The automotive movable body according to claim 6, wherein the processor is further capable of performing the following operations of:
calculating a moved distance before turning around covered before a driving signal capable of causing turning around at approximately 180° is sent to the actuator;
calculating a moved distance after turning around;
judging whether the moved distance after turning around is shorter than the moved distance before turning around or not, when the sensor detects the existence of an object; and
outputting to the actuator a driving signal capable of avoiding the detected object, when it is judged that the moved distance after turning around is shorter than the moved distance before turning around.

13. The automotive movable body according to claim 7, wherein the processor is further capable of performing the following operations of:
calculating a moved distance before turning around covered before a driving signal capable of causing turning around at approximately 180° is sent to the actuator;
calculating a moved distance after turning around;
judging whether the moved distance after turning around is shorter than the moved distance before turning around or not, when the sensor detects the existence of an object; and
outputting to the actuator a driving signal capable of avoiding the detected object, when it is judged that the moved distance after turning around is shorter than the moved distance before turning around.

14. The automotive movable body according to claim 8, wherein the processor is further capable of performing the following operations of:
calculating a moved distance before turning around covered before a driving signal capable of causing turning around at approximately 180° is sent to the actuator;
calculating a moved distance after turning around;
judging whether the moved distance after turning around is shorter than the moved distance before turning around or not, when the sensor detects the existence of an object; and
outputting to the actuator a driving signal capable of avoiding the detected object, when it is judged that the moved distance after turning around is shorter than the moved distance before turning around.

15. The automotive movable body according to claim 9, wherein the processor is further capable of performing the following operations of:
calculating a moved distance before turning around covered before a driving signal capable of causing turning around at approximately 180° is sent to the actuator;
calculating a moved distance after turning around;
judging whether the moved distance after turning around is shorter than the moved distance before turning around or not, when the sensor detects the existence of an object; and
outputting to the actuator a driving signal capable of avoiding the detected object, when it is judged that the moved distance after turning around is shorter than the moved distance before turning around.

16. A movable body control method,
the movable body comprising:
a driven wheel;
an actuator for driving the driven wheel;
a sensor for detecting an object which exists in the vicinity; and
a moved distance calculating unit for calculating a moved distance from a moving starting position, wherein
an operation of the driven wheel is controlled according to a detection result of the sensor,
the method comprising the steps of:
outputting to the actuator a driving signal capable of causing the body to move along an object;
judging whether the distance calculated by the moved distance calculating unit is up to a first distance or not;
outputting to the actuator a driving signal capable of causing the body to move in a direction which intersects with a segment connecting a position before moving with a position after moving, when it is judged that the distance is up to the first distance;
judging whether the distance calculated by the moved distance calculating unit is up to a second distance or not; and
outputting to the actuator a driving signal capable of causing the body to turn around at approximately 180°, when it is judged that the distance is up to the second distance or when the sensor detects an object.

17. The movable body control method according to claim 16, comprising further steps of:
outputting to the actuator a driving signal capable of causing the body to move toward an object detected by the sensor after moving is started;
calculating a distance to a detected object, when the sensor detects the object; and
judging whether the calculated distance is shorter than a predetermined value or not.
